(19) United States
(12) Patent Application Publication
(10) Pub. No.: US 2026/0111348 A1
(43) Pub. Date: Apr. 23, 2026

(54) USER INTERFACE-TEST-BASED AUTOMATION OF INTEGRATION LIFECYCLE AND CONFIGURATION PROCEDURES

(71) Applicant: SAP SE, Walldorf (DE)

(72) Inventor: Andreas Jahr, Karlsruhe (DE)

(21) Appl. No.: 18/920,484

(22) Filed: Oct. 18, 2024

(51) Int. Cl. G06F 11/36

(52) U.S. Cl. CPC G06F 11/3688; G06F 11/3684

(57) ABSTRACT

Arrangements for user interface-test-based automation of integration lifecycle and configuration procedures are provided. A test class for user interface testing may be generated according to automation steps. A test context template may be created. A context file for a configuration user interface test may be generated using the test context template. Execution and validation of the configuration user interface test may be performed. The test context template and the configuration user interface test may be released for automation. Test code and the test context template may be deployed to an automation framework. The configuration user interface test may be executed, via the automation framework, as a step to an integration automation procedure. Executing the configuration user interface test includes reusing the configuration user interface test where a configuration application programming interface is unavailable.

### TECHNICAL FIELD

The subject matter described herein relates generally to data processing and, in particular, to user interface-test-based automation of integration lifecycle and configuration procedures.

### BACKGROUND

Oftentimes single information technology (IT) services and systems do not suffice to implement entire business processes. Instead, the steps of the business process are distributed over multiple services. The activity and data flow between steps are achieved by passing data from one tenant of a service to another tenant of another service in an integration process. The lifecycle of integrations (e.g., setup, change, delete) is composed of a multitude of configuration activities, sometimes up to and beyond hundreds of individual activities required by the integration. It may be difficult to automate the configuration activities since, in many cases, automation relies on the existence of configuration application programming interfaces (APIs) that allow for the manipulation of the integration-relevant configuration items.

Oftentimes these configuration APIs are not developed and therefore do not exist, and only configuration user interfaces (UIs) are available. The lack of integration automation results in complex, error-prone, and time-consuming integration lifecycles.

### SUMMARY

Methods, systems, and articles of manufacture, including computer program products, are provided for reusing configuration UI tests where no dedicated configuration APIs are implemented. In one aspect, a computer-implemented method includes generating a test class for user interface testing according to automation steps; creating a test context template; generating a context file for a configuration user interface test using the test context template; executing and performing validation of the configuration user interface test; releasing the test context template and the configuration user interface test for automation; deploying test code and the test context template to an automation framework; and executing, via the automation framework, the configuration user interface test as a step to an integration automation procedure, wherein executing the configuration user interface test comprises reusing the configuration user interface test where a configuration application programming interface is unavailable.

In some variations one or more of the following can optionally be included. Structure of the context file is encapsulated in an automation support library. The context file includes test data prepared for a test context and an integration lifecycle context. The context file includes externalized test data used to input and output data in the test code. Each configuration user interface test is mapped to an automation step. An automation step may include creating, reading, updating, or deleting data. The context file is read by an automation support library that collects and returns output data and logs to an execution engine.

Articles are also described that comprise a tangibly embodied machine-readable medium operable to cause one or more machines (e.g., computers, etc.) to result in operations described herein. Similarly, computer systems are also described that may include a processor and a memory coupled to the processor. The memory may include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a basic block diagram of a system for UI-test-based automation in accordance with some example embodiments;

FIG. 2 depicts an illustrative computing environment for UI-test-based automation in accordance with some example embodiments;

FIGS. 3A and 3B depict an illustrative computing environment for UI-test-based automation in accordance with some example embodiments;

FIG. 4 depicts test code and related context file associated with UI-test-based automation in accordance with some example embodiments;

FIG. 5 depicts a flowchart illustrating a process for implementing UI-test-based automation in accordance with some example embodiments; and

FIG. 6 depicts a block diagram illustrating a computing system, in accordance with some example embodiments.

When practical, similar reference numbers denote similar structures, features, or elements.

### DETAILED DESCRIPTION

Aspects of the disclosure provide a technical solution that addresses problems associated with automating integration lifecycle and configuration procedures. In some aspects, dedicated configuration APIs need not be implemented and configuration UI tests are reused instead. UI tests manifest the knowledge of a UI structure and thus accurately reflect the latest UI version and changes from a previous version. Furthermore, browser-drivers used for testing allow the programmatic and direct access to productive UIs. Therefore, the usage of UI tests for configuration automation circumvent the necessity of configuration APIs. In some aspects, configuration UI tests are modified to consume externalized test data file (one set for the UI test, and another set for the integration lifecycle procedure) instead of formerly hard-coded test data. Advantageously, users setting up an integration only need to determine a handful of input parameters at the beginning of the execution of an integration lifecycle procedure and all configuration activities may then be carried out by an automation engine running an automation procedure without further manual configuration activities. Further aspects of the disclosure provide advantages over robotic process automation, which typically requires reverse engineering of the UI access for each UI change (labels, variables, screen layout etc.).

As used herein, the term “procedure” may refer to an “automation procedure,” an “integration automation procedure,” or an “integration lifecycle procedure.” As used herein, an “atomic (automation) operation” may refer to an “atomic (automation) procedure” or an “atomic (automation) method.”

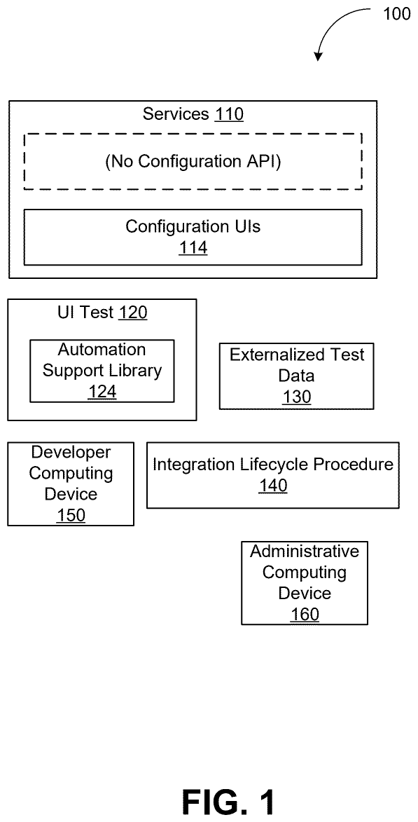

FIG. 1 depicts a basic block diagram of a system for UI-test-based automation in accordance with some example embodiments. Referring to FIG. 1, the system 100 may include one or more computing devices and/or other computing systems. For example, system 100 may include services 110 (e.g., IT/cloud services), a user interface (UI) test 120, externalized test data 130, an integration lifecycle procedure 140, a developer computing device 150, and an administrative computing device 160. Each service 110 may offer a configuration UI 114, but not necessarily a configuration API.

UI tests 120 may be used to test the configuration UIs 114 to determine whether the configuration UIs 114 are working as expected. In addition, the UI tests 120 may be used to automate lifecycle procedures of an integration (e.g., setting up, tearing down, changing integrations, etc. in integration lifecycle procedure 140). The UI test 120 may act as a proxy interface to the configuration UI 114. In some aspects, instead of being hard coded in the UI test 120, externalized test data 130 is fed in through a file. Two sets of externalized test data may be used: one being the test data used throughout the development to check that the configuration UI works as expected, and another being for the automated setup of the integration.

Automation support library 124 is introduced for less effort on the UI test development side and to ensure syncing with requirements needed from the integration lifecycle procedure. Automation support library 124 helps ensure that the automation developed based on the UI tests 120 works on the respective configuration UI 114. The automation support library 124 encapsulates the specifics for the test and the automation context and thus reduces the effort and complexity of having to support UI test and automation. For example, automation support library 124 may have two purposes: first, to encapsulate code that is to be reused across different configuration UIs and different services; and second, to ensure that for both UI tests and automation, the same or conceptually similar code (e.g., access and structure of input files and access to secrets) is executed.

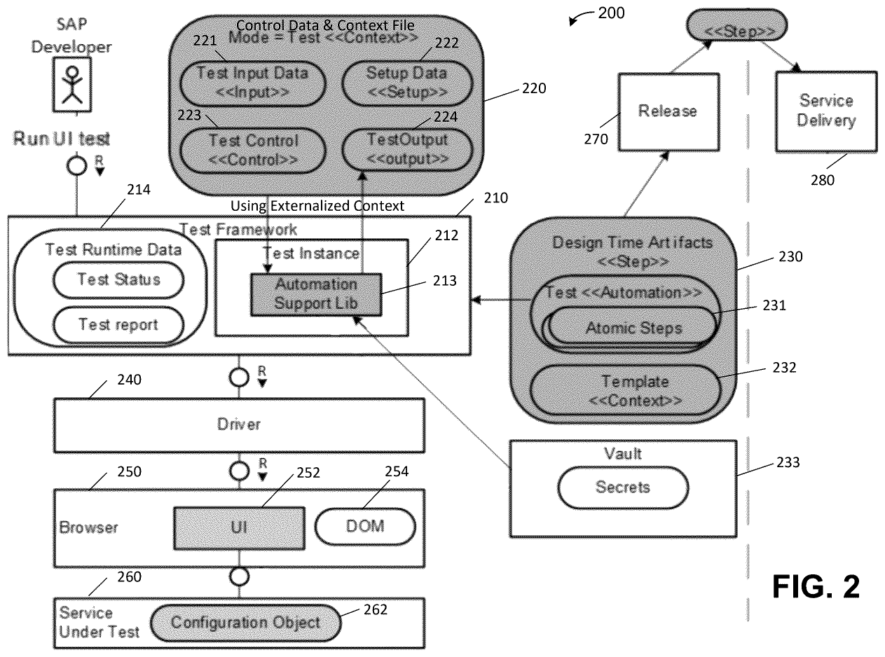

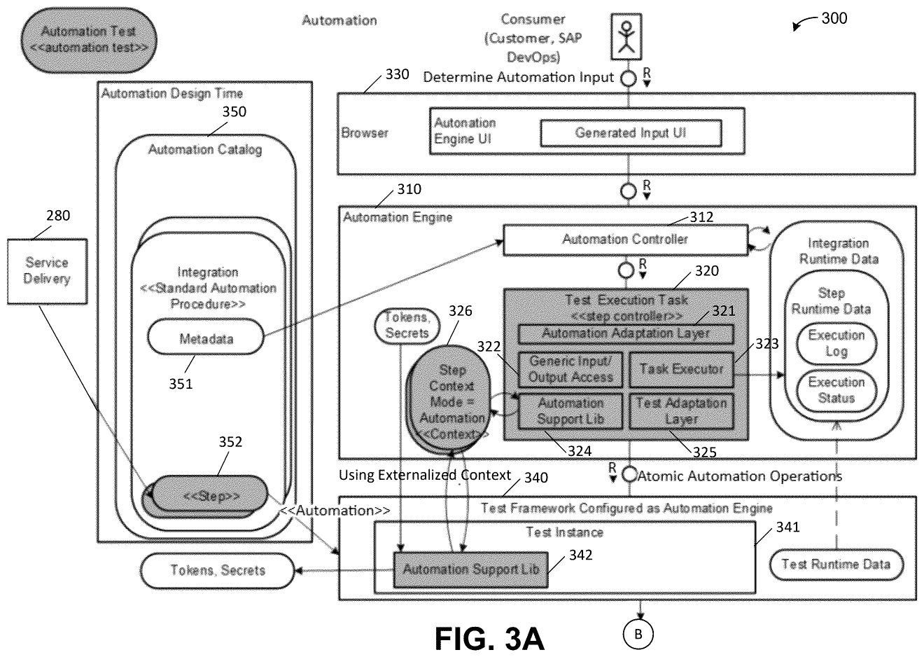

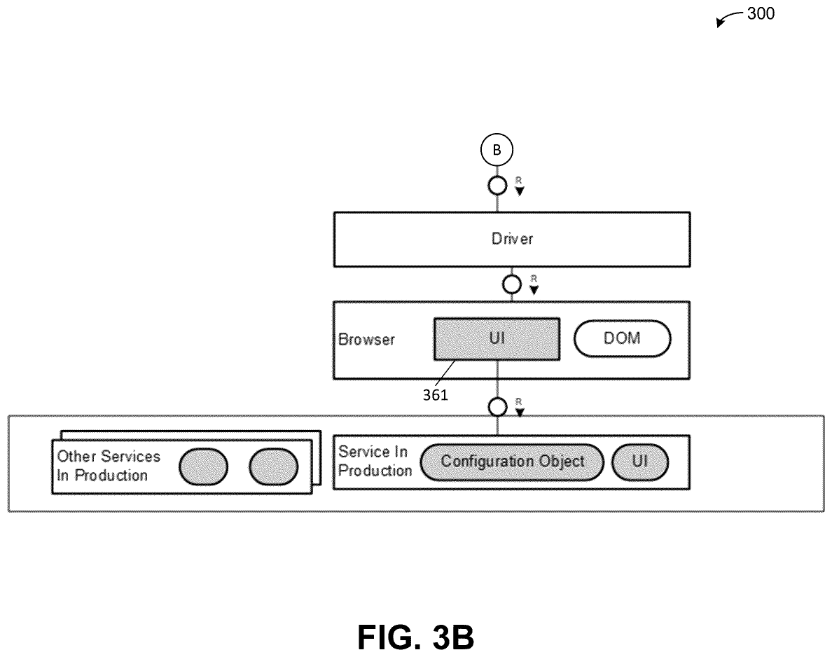

FIG. 2 depicts an illustrative computing environment 200 for UI-test-based automation in accordance with some example embodiments. FIGS. 3A and 3B depict an illustrative computing environment 300 for UI-test-based automation in accordance with some example embodiments. FIGS. 2 and 3A-B will be discussed together. FIG. 2 illustrates, from a UI test perspective, how UI tests are performed where there is no configuration API available. FIG. 2 illustrates a test framework 210 with test data 214 (runtime data). Aspects of the disclosure externalizes the test input by means of a context file (e.g., test context file 220). Test context file 220 may be defined with test input data 221 (e.g., name of an object, properties of an object, values of the properties, or the like), setup data 222 (e.g., credentials, name of a secret that can be retrieved from the vault 233, connection parameters for the driver, or the like needed to run a test), test control data 223, and test output data 224. An automation support library 213 may be used to ensure and simplify access to the context file (e.g., test context file 220). The automation support library 213 encapsulates knowledge about the structure of the context file and ensures that UI testing and integration lifecycle automation rely on the same context file structure.

As shown in FIG. 2, the design time artifacts (test code) 230 resides in a separate file. The design time artifacts 230 may include atomic (automation) steps/procedures 231 that are represented as one test each (e.g., an atomic step which can be a step in the automation procedure). The steps/procedures are developed with a specific purpose on the UI (e.g., creating a configuration object, deleting a configuration object, browsing/searching a configuration objection). Each atomic (automation) step may be implemented as a JUnit test (a test automation framework for the Java programming language). The developed code may be used to test the functionality of the configuration UI (for the underlying configuration object(s) 262).

The test framework 210 invokes the tests (and thus creates a test instance). The test 231 reads the test context file 220. The instance 212 then produces test runtime data 214 (e.g., test status and test report). In some examples, automation support library 213 may return data that is written back during execution of the test into the test output 224. In some examples, the test control data 223 may include control parameters that determine whether the test should be executed as an automation procedure (e.g., for the purpose of automation in a live environment) or as a UI test. In addition, the test control data 223 may specify a specific order in which to execute a test.

In some aspects, the testing framework 210 may perform UI testing using a browser driver 240 connected to a browser 250. A UI 252 (i.e., a UI page) may be loaded. The browser driver 240 may access a document object model (DOM) 254 that the browser builds up by having loaded and interpreted the code of the UI page 252. Thereby, manipulation through the UI 252 of a configuration object 262 in the service under test 260 is possible. Individual UI test cases (atomic/automation steps) may manipulate a specific configuration object through the respective configuration UI.

The UI test artifacts (step artifacts) now only comprise the test code and the test context template (e.g., names of input, error, control, and setup name-value pairs for test methods). These artifacts may be released (at 270) and delivered (at 280) as steps to an automation procedure.

As described in more detail below, once the automation procedure is executed, an automation engine 310 determines the steps needed and invokes for all UI-test-based automation steps, the test execution task module 320. The template file 232 is copied and serves as the context file for its step. Automation engine requests may be translated to context file accesses or interactions with the test framework. The test framework 340 may execute the UI tests (depicted as a running test instance 341) as required by the automation procedure definition of steps. The test instance 341 reads the context file 326 for input, control, and setup data and writes to the context file 326 for output and error data.

Referring to FIG. 3A, a desired integration lifecycle procedure may be selected, for example, from an automation catalog 350 via a UI of an automation engine 310. The automation catalog 350 may comprise a multitude of automation procedures consisting of multiple steps 352. An individual test case/UI test case (e.g., an atomic step 231 in FIG. 2) may correspond to a step 352 in the automation procedure (e.g., FIG. 3A). Moreover, in FIG. 2, the template 232 may define inputs and/or outputs needed to carry out the atomic steps 231.

Returning to FIG. 3A, the automation engine 310 may create a procedure instance that reads the automation procedure metadata 351. The automation engine 310 may create copies of the context file templates 326 for each UI-test-based automation step via a test execution task module 320.

The test execution task module 320 may include the following components:

Automation adaptation layer: The automation adaptation layer 321 implements task APIs defined by the automation engine and maps them to the core functionality of the test execution task represented by task executor 323.

Task Executor: The task executor 323 translates the automation domain to a generic test domain with externalized context data. It determines which atomic automation operation to choose, prepares the test framework execution parameters, determines when and what to read from and write to the context file 326 and to persist and/or return to the automation engine 310.

Test Adaptation layer: This adaptation layer 325 implements the test framework APIs and translates task executor 323 requests from its generic test domain to the specific test framework. With this abstraction it is possible to support multiple different test frameworks by introducing multiple different adaptation layers.

Generic Input/Output Access: The generic input/output access component 322 implements automation-specific functionality such as handling already existing input parameters (stemming from outputs of previous steps or reusable user input).

Automation Support Library: The automation support library 324 is a reuse component used also in the test code. The reused functionality allows for low-level access to the context file. It encapsulates the knowledge about the structure of context file and ensures that UI testing and integration lifecycle automation always rely on the same context file structure.

The automation engine 310 may be triggered (either manually or with a trigger). An automation controller 312 (e.g., a main server) may read in the integration procedure and understand, based on the metadata 351 describing the integration procedure, the next step to carry out for the automation procedure. In aspects of the disclosure, the step would be a step that is implemented as a UI test, invoking the test execution task module 320. Each step may correspond to a task. Test execution task module 320 may handle UI tests as automation procedures. The input parameters to the task execution task module 320 may be determined by executing one of the atomic steps 352. The task execution task module 320 may invoke a test execution framework 340 (similar to test framework 210 in FIG. 2) so that the test code can be carried out. A test instance 341 may be created. The automation support library 342 may be invoked by the test framework 340 with the invocation of a test case. The automation support library 342 reads the previously captured input data residing in the context file 326. As a result, referring to FIG. 3B (through a similar mechanism as for the UI test in FIG. 2), data that is fed into the UI 361 is live data for the purposes of creating the integration.

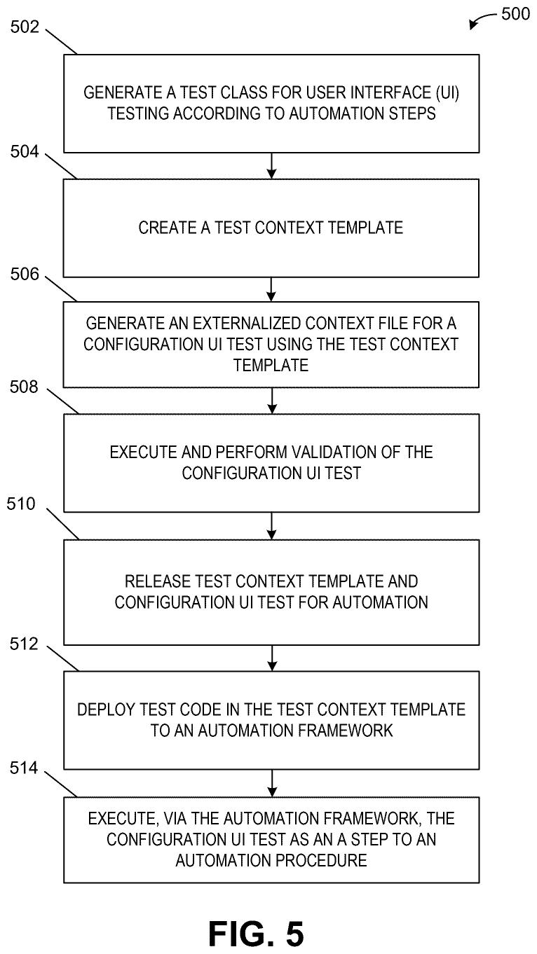

FIG. 5 depicts a flowchart illustrating a process for implementing UI-test-based automation in accordance with some example embodiments. Referring to FIG. 5, at step 502, a test class for user interface testing may be generated according to automation steps. For example, a test class may be written according to recommended or given structures for atomic procedures. An automation step may include creating, updating, or deleting data. In some embodiments, UI tests (as atomic automation steps) are provided not only to create, delete, or update data, but to also to read one or multiple configuration objects. For example, reading is needed within an automation procedure for the purpose of searching for input data candidates (then to be presented to the user for selection by the user) and validating the existence or absence of input data in already existing configuration objects.

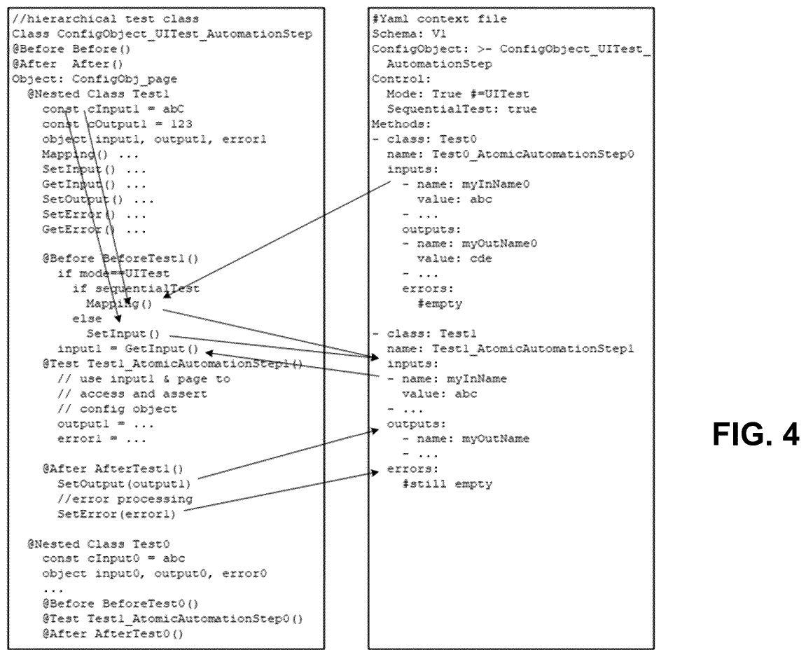

At step 504, a context template may be created. At step 506, a context file for a configuration user interface test may be generated using the test context template. Each configuration user interface test may be mapped to an automation step. For example, a context file (externalized, separate file from the test class) may be generated for a UI test by applying the context template. In some examples, the context file may include test data prepared for a test context and an integration lifecycle context. In some examples, the context file may include externalized test data used to input and output data in the test code. In this regard, FIG. 4 depicts test code and related context file associated with UI-test-based automation in accordance with some example embodiments. As discussed above, the context file may be read by an automation support library that collects and returns output data and logs to an execution engine.

At step 508, the configuration user interface test may be executed (e.g., on a browser). In addition, functionality and performance of the UI test may be validated. At step 510, the test context template and the configuration user interface test may be released and published for automation. At step 512, test code and the test context template may be deployed to (transported, and imported to) an automation framework. At step 514, the configuration user interface test may be executed, via the automation framework, as a step to an integration automation procedure. The configuration user interface test is reused. Additionally, in some example embodiments, a configuration application programming interface is unavailable (and only a configuration user interface is available).

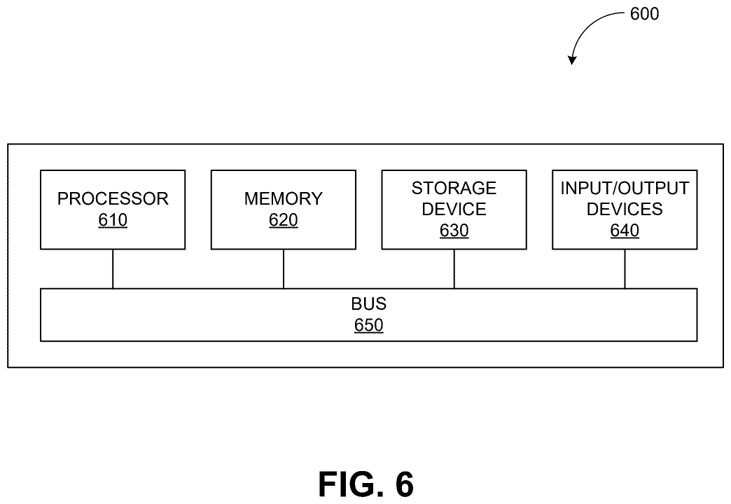

FIG. 6 depicts a block diagram illustrating a computing system 600 consistent with implementations of the current subject matter. Referring to FIGS. 1-6, the computing system 600 can be used to implement UI-test-based automation 200, 300 and/or any components therein.

As shown in FIG. 6, the computing system 600 can include a processor 610, a memory 620, a storage device 630, and input/output devices 640. The processor 610, the memory 620, the storage device 630, and the input/output devices 640 can be interconnected via a system bus 650. The processor 610 is capable of processing instructions for execution within the computing system 600. Such executed instructions can implement one or more components of, for example, UI-test-based automation 200, 300. In some implementations of the current subject matter, the processor 610 can be a single-threaded processor. Alternately, the processor 610 can be a multi-threaded processor. The processor 610 is capable of processing instructions stored in the memory 620 and/or on the storage device 630 to display graphical information for a user interface provided via the input/output device 640.

The memory 620 is a computer readable medium such as volatile or non-volatile that stores information within the computing system 600. The memory 620 can store data structures representing configuration object databases, for example. The storage device 630 is capable of providing persistent storage for the computing system 600. The storage device 630 can be a solid-state device, a floppy disk device, a hard disk device, an optical disk device, a tape device, and/or any other suitable persistent storage means. The input/output device 640 provides input/output operations for the computing system 600. In some implementations of the current subject matter, the input/output device 640 includes a keyboard and/or pointing device. In various implementations, the input/output device 640 includes a display unit for displaying graphical user interfaces.

According to some implementations of the current subject matter, the input/output device 640 can provide input/output operations for a network device. For example, the input/output device 640 can include Ethernet ports or other networking ports to communicate with one or more wired and/or wireless networks (e.g., a local area network (LAN), a wide area network (WAN), the Internet).

In some implementations of the current subject matter, the computing system 600 can be used to execute various interactive computer software applications that can be used for organization, analysis and/or storage of data in various (e.g., tabular) format (e.g., Microsoft Excel®, and/or any other type of software). Alternatively, the computing system 600 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities (e.g., SAP Integrated Business Planning add-in for Microsoft Excel as part of the SAP Business Suite, as provided by SAP SE, Walldorf, Germany) or can be standalone computing products and/or functionalities. Upon activation within the applications, the functionalities can be used to generate the user interface provided via the input/output device 640. The user interface can be generated and presented to a user by the computing system 600 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A computer-implemented method comprising:
generating a test class for user interface testing according to automation steps; creating a test context template;
generating a context file for a configuration user interface test using the test context template;
executing and performing validation of the configuration user interface test; releasing the test context template and the configuration user interface test for automation;
deploying test code and the test context template to an automation framework; and
executing, via the automation framework, the configuration user interface test as a step to an integration automation procedure, wherein executing the configuration user interface test comprises reusing the configuration user interface test where a configuration application programming interface is unavailable.

Example 2: The computer-implemented method of Example 1, further comprising: encapsulating structure of the context file in an automation support library.

Example 3: The computer-implemented method of any of Examples 1-2,

Example 4: The computer-implemented method of any of Examples 1-3, wherein the context file comprises externalized test data used to input and output data in the test code.

Example 5: The computer-implemented of any of Examples 1-4, wherein each configuration user interface test is mapped to an automation step.

Example 6: The computer-implemented of any of Examples 1-5, wherein an automation step comprises creating, reading, updating, or deleting data.

Example 7: The computer-implemented of any of Examples 1-6, wherein the context file is read by an automation support library that collects and returns output data and logs to an execution engine.

Example 8: A system comprising:
generating a test class for user interface testing according to automation steps; creating a test context template;
generating a context file for a configuration user interface test using the test context template;
executing and performing validation of the configuration user interface test;
releasing the test context template and the configuration user interface test for automation;
deploying test code and the test context template to an automation framework; and
executing, via the automation framework, the configuration user interface test as a step to an integration automation procedure, wherein executing the configuration user interface test comprises reusing the configuration user interface test where a configuration application programming interface is unavailable.

Example 9: The system of Example 8, further comprising: encapsulating structure of the context file in an automation support library.

Example 10: wherein the context file comprises test data prepared for a test context and an integration lifecycle context.

Example 11: The system of any of Examples 8-10, wherein the context file comprises externalized test data used to input and output data in the test code.

Example 12: The system of any of Examples 8-11, wherein each configuration user interface test is mapped to an automation step.

Example 13: The system of any of Examples 8-12, wherein an automation step comprises creating, reading, updating, or deleting data.

Example 14: The system of any of Examples 8-13, wherein the context file is read by an automation support library that collects and returns output data and logs to an execution engine.

Example 15: A non-transitory computer-readable storage medium including program code which when executed by at least one processor causes operations comprising:
generating a test class for user interface testing according to automation steps; creating a test context template;
generating a context file for a configuration user interface test using the test context template;
executing and performing validation of the configuration user interface test; releasing the test context template and the configuration user interface test for automation;
deploying test code and the test context template to an automation framework; and
executing, via the automation framework, the configuration user interface test as a step to an integration automation procedure, wherein executing the configuration user interface test comprises reusing the configuration user interface test where a configuration application programming interface is unavailable.

Example 16: The non-transitory computer-readable storage medium of Example 15, wherein the context file comprises test data prepared for a test context and an integration lifecycle context.

Example 17: The non-transitory computer-readable storage medium of Example 15-16, wherein the context file comprises externalized test data used to input and output data in the test code.

Example 18: The non-transitory computer-readable storage medium of Example 15-17, wherein each configuration user interface test is mapped to an automation step.

Example 19: The non-transitory computer-readable storage medium of Example 15-18, wherein an automation step comprises creating, reading, updating, or deleting data.

Example 20: The non-transitory computer-readable storage medium of Example 15-19, wherein the context file is read by an automation support library that collects and returns output data and logs to an execution engine.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed IS:

1. A computer-implemented method comprising:
generating a test class for user interface testing according to automation steps;
creating a test context template;
generating a context file for a configuration user interface test using the test context template;
executing and performing validation of the configuration user interface test;
releasing the test context template and the configuration user interface test for automation;
deploying test code and the test context template to an automation framework; and
executing, via the automation framework, the configuration user interface test as a step to an integration automation procedure, wherein executing the configuration user interface test comprises reusing the configuration user interface test where a configuration application programming interface is unavailable.

2. The computer-implemented method of claim 1, further comprising:
encapsulating structure of the context file in an automation support library.

3. The computer-implemented method of claim 1, wherein the context file comprises test data prepared for a test context and an integration lifecycle context.

4. The computer-implemented method of claim 1, wherein the context file comprises externalized test data used to input and output data in the test code.

5. The computer-implemented method of claim 1, wherein each configuration user interface test is mapped to an automation step.

6. The computer-implemented method of claim 1, wherein an automation step comprises creating, reading, updating, or deleting data.

7. The computer-implemented method of claim 1, wherein the context file is read by an automation support library that collects and returns output data and logs to an execution engine.

8. A system comprising:
at least one processor; and
at least one memory including program code which when executed causes the system to provide operations comprising:
generating a test class for user interface testing according to automation steps;
creating a test context template;
generating a context file for a configuration user interface test using the test context template;
executing and performing validation of the configuration user interface test;
releasing the test context template and the configuration user interface test for automation;
deploying test code and the test context template to an automation framework; and
executing, via the automation framework, the configuration user interface test as a step to an integration automation procedure, wherein executing the configuration user interface test comprises reusing the configuration user interface test where a configuration application programming interface is unavailable.

9. The system of claim 8, further comprising:
encapsulating structure of the context file in an automation support library.

10. The system of claim 8, wherein the context file comprises test data prepared for a test context and an integration lifecycle context.

11. The system of claim 8, wherein the context file comprises externalized test data used to input and output data in the test code.

12. The system of claim 8, wherein each configuration user interface test is mapped to an automation step.

13. The system of claim 8, wherein an automation step comprises creating, reading, updating, or deleting data.

14. The system of claim 8, wherein the context file is read by an automation support library that collects and returns output data and logs to an execution engine.

15. A non-transitory computer-readable storage medium including program code which when executed by at least one processor causes operations comprising:
generating a test class for user interface testing according to automation steps;
creating a test context template;
generating a context file for a configuration user interface test using the test context template;
executing and performing validation of the configuration user interface test;
releasing the test context template and the configuration user interface test for automation;
deploying test code and the test context template to an automation framework; and
executing, via the automation framework, the configuration user interface test as a step to an integration automation procedure, wherein executing the configuration user interface test comprises reusing the configuration user interface test where a configuration application programming interface is unavailable.

16. The non-transitory computer-readable storage medium of claim 15, wherein the context file comprises test data prepared for a test context and an integration lifecycle context.

17. The non-transitory computer-readable storage medium of claim 15, wherein the context file comprises externalized test data used to input and output data in the test code.

18. The non-transitory computer-readable storage medium of claim 15, wherein each configuration user interface test is mapped to an automation step.

19. The non-transitory computer-readable storage medium of claim 15, wherein an automation step comprises creating, reading, updating, or deleting data.

20. The non-transitory computer-readable storage medium of claim 15, wherein the context file is read by an automation support library that collects and returns output data and logs to an execution engine.
